(19) United States
(12) Patent Application Publication
(10) Pub. No.: US 2026/0203140 A1
(43) Pub. Date: Jul. 16, 2026

(54) REWARD BASED RESOURCE ALLOCATION WITH AUTOMATIC SCALE UP ADAPTATION

(71) Applicant: Dell Products L.P., Round Rock, TX (US)

(72) Inventors: CHING-YUN CHAO, Austin, TX (US); STEVEN J. Petrucci, Bellevue, WA (US)

(21) Appl. No.: 19/025,760

(22) Filed: Jan. 16, 2025

(51) Int. Cl. G06F 9/50

(52) U.S. Cl. CPC G06F 9/5094

(57) ABSTRACT

Methods and systems for managing components hosted in a computing environment are disclosed. The components may be managed by a trained inference model that is trained using a custom reward condition set by an administrator and/or user of the computing environment in order to optimize resource allocations and/or usage of the components based on one or more needs of the administrator and/or user. As the computing environment is scaled up or down, the trained inference model may be automatically adapted to a new size of the computing environment without requiring retraining of the trained inference model using the new size of the computing environment.

### FIELD

Embodiments disclosed herein relate generally to component control. More particularly, embodiments disclosed herein relate to systems and methods to manage components (e.g., data processing systems) hosted in a computing environment.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with one or more embodiments.

FIGS. 2A-2B show data flow diagrams in accordance with one or more embodiments.

FIGS. 3A-3B show an implementation example in accordance with one or more embodiments.

FIGS. 4A-4B show flowcharts in accordance with one or more embodiments.

FIG. 5 shows a block diagram illustrating a computing device in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing components hosted in a computing environment. In embodiments, the components may be hardware components, software components, or a combination of both thereof. In particular, the components may be managed by a trained machine learning model (e.g., a trained neural network-based machine learning model or the like) and the trained machine learning model may be automatically adapted to any changes to the computing environment that causes a change to a number of the components (e.g., a scale up of the computing environment that causes additional components to be added, or the like) without requiring retraining of the trained machine learning model.

For example, assume that the environment is an artificial intelligence (AI) farm environment with a collection of AI server machines. Each of these server machines may include graphical processing units (GPUs) and other similar components (e.g., processors, storage devices, or the like) that may be used to execute AI-based processes (e.g., AI training and/or retraining, hosting trained AI models, or the like) and/or non-AI based processes (e.g., application hosting, data storage services, or the like).

These environments may have high demands but, however, may lack efficient component resource allocation and optimization capabilities to meet these high demands. For example, an environment may include server racks, each of which is installed with multiple GPU-based systems that are all powered-on or powered-off together when power is supplied to a server rack (e.g., when a server rack is powered-on or powered off). As a result, one server rack may be powered-on for use of only a single GPU-based system while another server rack that is not yet at full capacity is still available, resulting in additional and inefficient power usage (e.g., power consumption) in the computing environment.

Furthermore, if additional server racks are added to the computing environment to meet higher demands, any processes (e.g., machine learning based and/or non-machine learning based programs/processes) will have to be reconfigured (e.g., retrained) to adapt to the new size of the scaled-up computing environment, which also requires use of additional limited and expensive computing resources (e.g., for the reconfiguration).

To overcome the above-discussed limitations of and in order to provide a computing environment with improved component resource allocation and optimization capabilities, embodiments disclosed herein provide systems and methods for managing the components in these computing environments using a trained machine learning model that can be automatically adapted to any scale-ups in the computing environment without requiring retraining of the trained machine learning model.

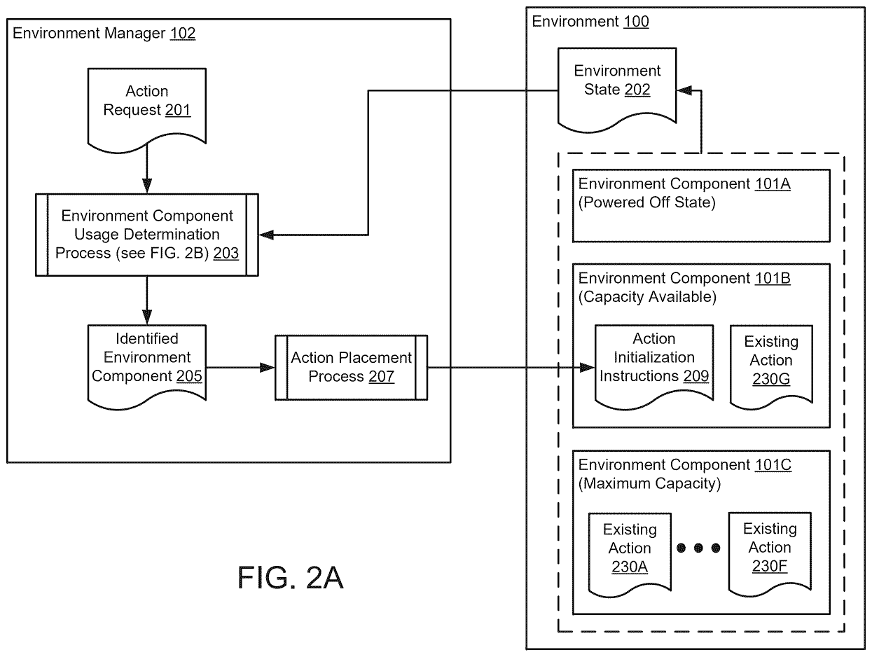

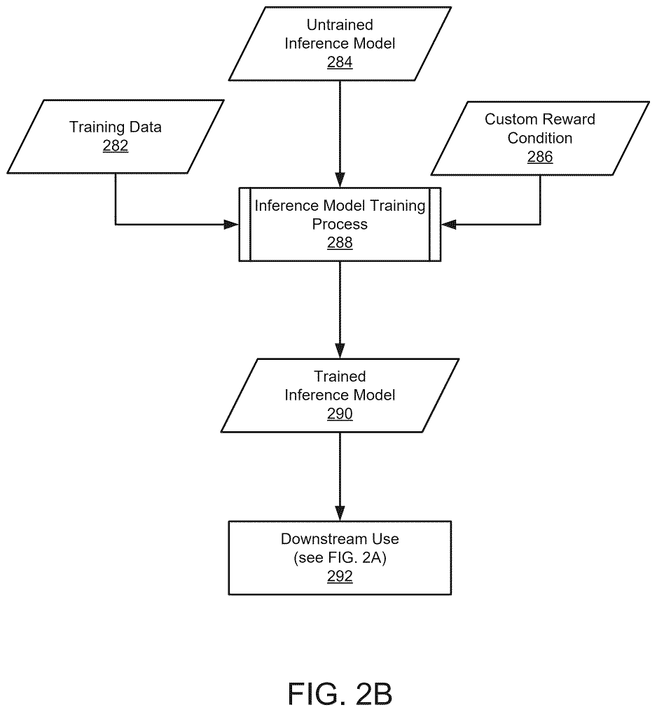

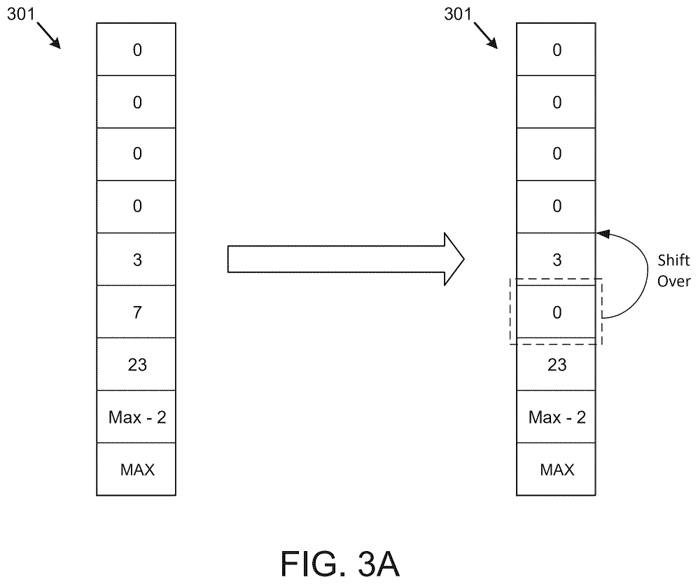

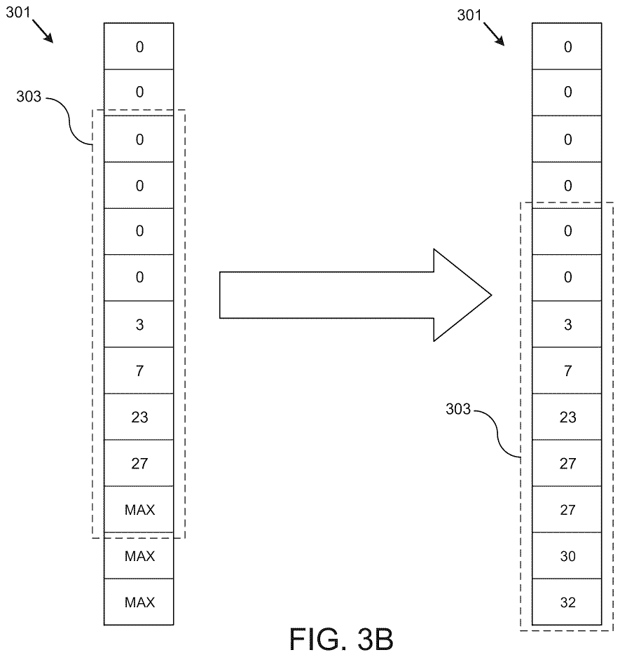

In particular, as discussed in more detail below in reference to FIGS. 2A-3B, a machine learning model may be trained based on a reward function (e.g., power consumption-based reward function, or the like) to select components within a computing environment that would return the highest return reward (e.g., lowest power consumption use) while still being able to fulfill actions requested by one or more users wishing to use the components of the computing environment.

Furthermore, as also discussed in more detail below in reference to FIGS. 2A-3B using a vector representation of the components and a sliding scale system, the trained model may be automatically adapted to any changes in the computing environment (e.g., a scale up or scale down of the number of components) without requiring any retraining of the trained machine learning model.

As a result, embodiments disclosed herein not only provide an improvement to component management related technology but also provide a direct improvement to the operations and functionalities of the components themselves. For example, assume again that the components being controlled are AI server machines (e.g., AI server racks) comprising GPUs. By ensuring that each AI server rack is utilized in the most efficient manner to minimize consumption of limited resources (e.g., minimize power consumption, or the like) in the computing environment, the operations and functionalities (e.g., shelf-life, etc.) of these GPUs may be improved by reducing a risk of power failure to the computing environment resulting from over consumption of the limited resources.

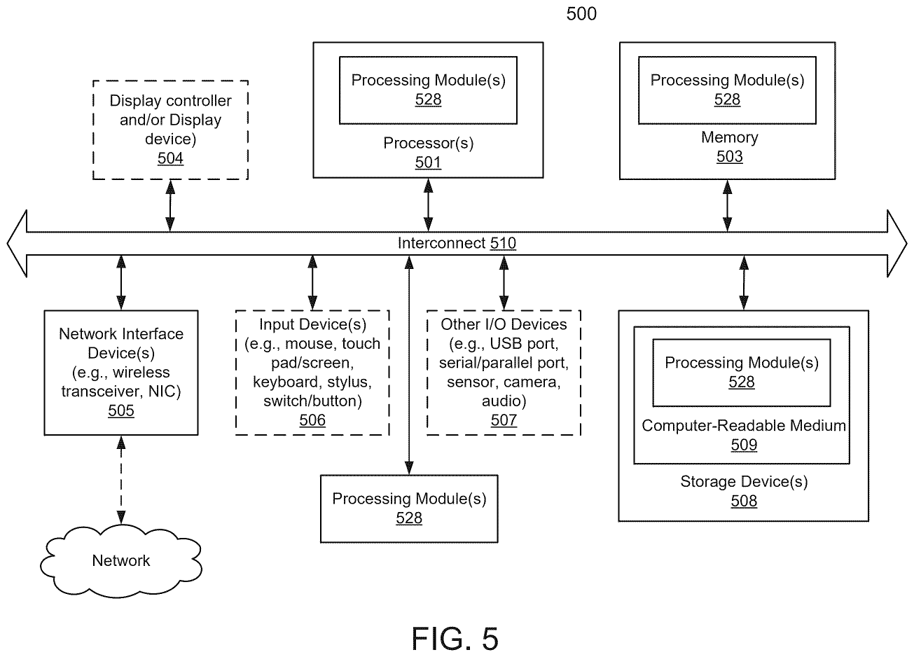

Additionally, by preventing the need for retraining of the trained machine learning model each time the computing environment changes, limited computing resources (e.g., processing power, storage space, etc.) required for such retraining can advantageously be saved and used for other processes (e.g., providing user requested services, or the like) thereby improving the overall functionality of a data processing system (e.g., a computer as shown in FIG. 5 or the like) hosting said trained machine learning model.

Other advantageous and improvements provided by embodiments disclosed herein may become apparent has more details regarding embodiments disclosed herein are discussed below in reference to the figures.

In embodiments, a method for managing components hosted in a computing environment may include: obtaining an action request comprising an action to be fulfilled by the components; using the action request, an environment state of the computing environment, and a trained machine learning model to obtain a component to fulfill the action, the component being one of the components, and the component being one determined by the trained machine learning model based on the action request and environment state as a highest return reward component from among the components; and providing action initialization instructions to the component to cause the component to fulfill the action.

The trained machine learning model is a Double Q-learning deep neural network algorithm-based model comprising a Q-function.

The Q-function is based on a component utilization and a component power consumption of the components.

Each of the components is a powered-off state component, a capacity-available state component, or a maximum capacity state component, and the highest return reward component is a component among the components that can be utilized to fulfil the action while causing a least number of the powered-off state components to be powered-on.

Each of the components is a server rack comprising one or more hardware devices for hosting and processing the action, and powering on one component of the component powers on all of the one or more hardware devices of the one component while powering off the one component powers off all of the one or more hardware devices of the one component.

Each of the one or more hardware devices is a graphical processing unit (GPU).

The trained machine learning model is trained using a fixed number of the components.

An updated computing environment may be obtained when new components are added or removed from the computing environment to cause the fixed number of the components to increase or decrease, respectively, to a new fixed number different from the fixed number before the new components were added or removed, and the trained machine learning model is applied to the updated computing environment with the new fixed number of the components without being retrained using the new fixed number.

The method may further include, and after the computing environment has become the updated computing environment: generating a vector diagram comprising vectors, a number of the vectors being identical to the new fixed number of the components; overlapping a sliding scale over the vector diagram, a size of the sliding scale being identical to the fixed number of the components on which the trained machine learning model was trained; and adjusting the sliding scale across the vector diagram to apply the trained machine learning model to only the vectors covered by the sliding scale, the adjusting being performed in response to receiving a new action request after the computing environment has become the updated computing environment.

The components are arranged as the vectors of the vector diagram in an order comprising: powered-off state components of the components at one end of the vector diagram; maximum capacity state components of the components at an opposite end of the vector diagram; and capacity-available state components of the components between the powered-off state components and the maximum capacity state components, and the sliding scale is moved across the vector diagram to cover a largest number of the capacity-available state components within a boundary of the sliding scale that is delimited by the size of the sliding scale.

A non-transitory media may include instructions that when executed by at least a processor of a data processing system cause the computer-implemented method to be performed by the data processing system.

A data processing system may include the non-transitory media and a processor, and may perform the computer-implemented method when processor executes the instructions in the non-transitory media.

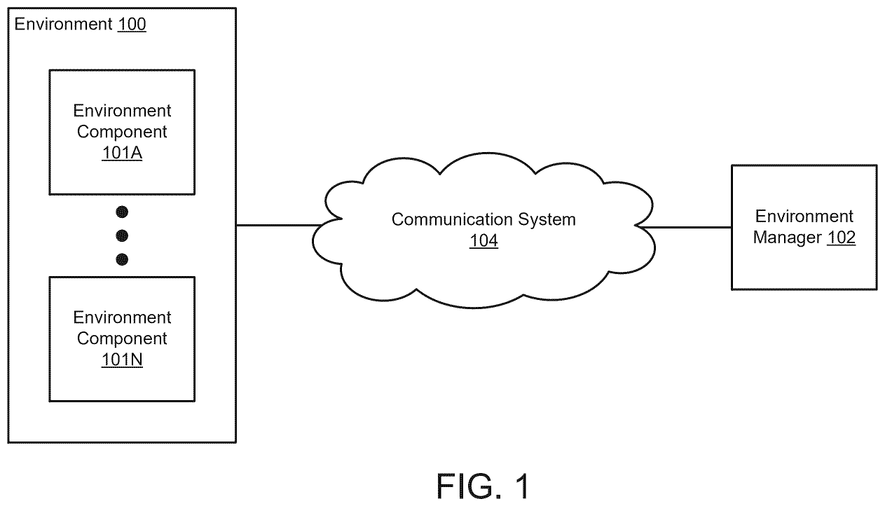

Turning to FIG. 1, a block diagram illustrating a system in accordance with an embodiment is shown. The system shown in FIG. 1 may provide computer implemented services. The computer implemented services may include any type and quantity of computer implemented services. For example, the computer implemented services may include data storage services, instant messaging services, database services, virtual machine instantiation and usage services, AI related services (e.g., model training, model hosting, model configuration services, or the like, and/or any other type of service that may be implemented with a computing device.

To provide the above noted functionalities, the system of FIG. 1 may include an environment 100 (also referred to herein as a “computing environment”). The environment 100 may be a server farm, a deployment, and/or any other type of physical location that is capable of hosting one or more environments components 101A-101N that are configured to provide the above-listed computer implemented services.

In embodiments, each environment component 101A-101N may be a, or a collection of, physical components (e.g., server blades, data processing systems, or the like). For example, each of the environment components 101A-101N may be a server rack installed without GPU-based computing systems configured to function as an AI server machine. In this example, the server rack may be configured such that powering the server rack off or on powers off (or on) all of the GPU-based computing systems within that server rack (e.g., all GPU-based computing systems within that server rack are either all on or all off at the same time depending on whether power is provided to that server rack).

Other configurations of the environment components 101A-101N may be utilized without departing from the scope of embodiments disclosed herein. For example, each server rack may have any combination of data processing systems (e.g., server blades) configured to provide any combination of the above-discussed computer implemented services. As one example, a server rack may have five (5) GPU-based computing systems for providing AI related services and five (5) storage system-based computing systems for providing data storage and/or database services.

To provide the computer implemented services, each data processing system (e.g., associated with/installed on each environment component 101A-101N) may include various hardware components (e.g., processors, memory modules, storage devices, etc.) and host various software components (e.g., operating systems, application, startup managers such as basic input-output systems, etc.).

The software components may be implemented using various types of services. For example, each data processing system may host various services that provide the computer implemented service (e.g., application services, virtual machine related services) and/or services that manage the operation of these services (e.g., management services). The aggregate (e.g., combination) of the management and application services may be a complete service that provide desired functionalities.

To manage the environment 100 (namely, the environment components 101A-101N of the environment 100), the system of FIG. 1 may include an environment manager 102.

Environment manager 102 may include various hardware components (e.g., processors, memory modules, storage devices, etc.) and host various software components (e.g., operating systems, application, startup managers such as basic input-output systems, etc.). These hardware and software components may provide the functionalities (e.g., the communication with and management of the data processing systems) of the environment manager 102.

In one example, the environment manager 102 may be a computing device (e.g., computing device of FIG. 5) such as a desktop computer or server that is used by administrators of the environment 100 to communicate with and manage the environment components 101A-101N. The environment manager 102 may also communicate with user devices (e.g., computers, laptops, cell phones, tablets, or the like) (not shown in FIG. 1) of users who wish to use the environment components 101A-101N of environment 100.

Additionally, although environment manager 102 is shown to be remote to the environment 100, embodiments disclosed herein are not limited to such a configuration. More specifically, in some embodiments, the environment manager 102 may be disposed within the environment 100 (e.g., at the physical location of environment 100).

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the Internet Protocol).

While FIG. 1 is illustrated as including a limited number of specific components, a system in accordance with an embodiment may include fewer, additional, and/or different components than those illustrated therein.

To further clarify embodiments disclosed herein, a data flow diagram in accordance with embodiments disclosed herein are shown in FIGS. 2A and 2B.

Starting with FIG. 2A, in this data flow diagram of FIG. 2A, flows of data and processing of data are illustrated using different sets of shapes. A first set of shapes (e.g., 201, 202, 205, 209, etc.) is used to represent data structures (e.g., files, documents, data packets, or the like), a second set of shapes (e.g., 203, 207, etc.) is used to represent processes performed using and/or that generate data, and a third set of shapes (e.g., 102, 100, 101A, etc.) is used to components and/or devices that perform (e.g., execute) the processes shown using the second set of shapes.

The data flow diagram of FIG. 2A may be performed by any of the components (e.g., any of the environment components 101A-101N and the environment manager 102 of FIG. 1). In the description below, the data flow diagram of FIG. 2A will be discussed as being performed by three (3) environment components (e.g., 101A, 101B, 101C) in combination with an environment manager 102. Although the environment manager 102 is described in FIG. 2A as interacting with only three (3) environment components, in embodiments, the environment manager 102 may interact with any number of the environment components 101A-101N without departing from the scope of embodiments disclosed herein.

Additionally, the data flow diagram of FIG. 2A will be discussed specifically with respect to the environment 100 being an AI server farm with each environment components (e.g., 101A, 101B, 101C) being AI servers containing a plurality of GPU-based computing systems that are configured to provide AI related services. More specifically, assume for this example that: (i) the environment 100 is a data center with N racks of AI server machines; (ii) each rack has M AI server machines (e.g., the GPU-based computing systems); and each AI server machine has L GPUs. Further assume that users (e.g., of environment 100) have workloads (e.g., actions) that require allocation of these AI server machines and their GPUs. To minimize power consumption within environment, further assume that an entire rack of AI server machines (e.g., an environment component 101A) is powered off when none of the AI server machines are in use (e.g., one of the AI server machines are allocated an action/workload), and that the rack of AI server machines can be powered on when the AI server machines of this rack are needed.

However, embodiments disclosed herein should not be limited to such an example configuration and may be applied to other types of environments 100 hosting other types of environment components 101A-101N.

As shown in FIG. 2A, environment manager 102 may obtain an action request 201. The action request 201 may be obtained by a user and/or other entity) wishing to use the environment components 101A-101C of environment 100. The action request 201 may include an action (e.g., a workload or workloads) to be fulfilled (e.g., processed, executed, or the like) by one or more of the environment components 101A-101C. For example, the action request 201 may include a workload of instantiating an AI model on one or more of the GPU-based computing systems of the environment components 101A-101C.

In embodiments, the action request 201 may be ingested, along with an environment state 202 of the environment 100, into an environment component usage determination process 203.

The environment state 202 may be data (or a collection of data) that includes any type of information regarding a current operating state of the environment 100. The operating state of the environment 100 may include, for example, but not limited to: a total power consumption of the environment 100; a maximum power consumption limit of the environment; how many environment components 101A-101C are powered on or powered off; how many AI server machines of each environment components 101A-101C are being utilized; a GPU allocation rate of each AI server machine of each environment components 101A-101C; how many GPUs and/or AI server machines are still available within each environment components 101A-101C; and/or any other type of operating data/statistics that provide information regarding a current operating state of the environment 100.

In embodiments, the environment state 202 may be obtained (e.g., collected, provided to, or the like) by environment manager 102 at a predetermined interval. The predetermined interval may be any amount of time (e.g., 1 second, 30 seconds, 1 minute, 1 hour, 1 day, or the like) set by an administrator of the environment manager 102 and/or the environment 100. Thus, the environment manager 102 may advantageously have constant and dynamic awareness of the operating state (e.g., limited resource usage, or the like) of the environment 100.

In the context of the non-limiting example discussed above (e.g., the AI server farm example), the environment state may be shown as: The state s[N] is a vector of N elements where each element represents GPU allocation status of a rack. For example, s[k], wherein 1≤k≤N, represents the number of GPUs that are allocated on rack k. In other words, the content of s[k] is a scalar value of allocated resources (e.g., GPUs) or 0≤s[k]≤M×L, where 1≤k≤N.

Turning first to FIG. 2B, the environment component usage determination process 203 will be described in more detail in FIG. 2B. In particular, FIG. 2B shows a data flow diagram for training a machine learning model that will be used to ingest action request 201 and environment state 202 in order to generate one or more inferences (e.g., which environment component 101A-101C to utilize to fulfil action request 201, or the like).

In the data flow diagram of FIG. 2B, components and data (e.g., trained or untrained models, time-series data, or the like) are shown using a first set of shapes (e.g., 284, 282, 286, 290, etc.), processes using the data and/or components are shown using a second set of shapes (e.g., 288, etc.), and uses of the data and/or components are shown using a third set of shapes (e.g., 292, etc.).

As shown in FIG. 2B, training data 282, an untrained inference model 284, and a custom reward condition 286 may be ingested into inference model training process 288 to obtain trained inference model 290.

In embodiments, the training data 282 may include past (e.g., historic) and/or simulated versions of the environment state 202 and/or action requests 201. The training data 282 may also include data obtained from other environments that are set up similarly as environment 100. The training data 282 may be provided in any format (e.g., time series, non-time series, a list, labeled, unlabeled, or the like) without departing from the scope of embodiments disclosed herein.

The untrained inference model 284 may be a machine learning model that is based on a deep machine learning (ML) with Q-learning functions (e.g., a model configured to combine Q-learning with deep neural network, also referred to herein as a “Double Q-learning deep neural network algorithm-based model”). In particular, the Q-learning functions may use a Q-value (e.g., a reward function) that estimates how good an action (e.g., inference) generated by the eventually trained inference model 290 would improve or degrade a state (e.g., environment state 202) of an environment 100 to which the trained inference model 290 is applied. The rating of the action may be based on one or more user-defined optimization objectives for the environment such as, but not limited to: optimize GPU resource utilization; minimizing power consumption; meeting or exceeding workload throughput and latency performance requirements; or the like.

In embodiments, a custom Q-value may be set up as custom reward condition 286. In the context of the non-limiting example discussed above (e.g., the AI server farm example), the custom reward condition 286 may be based on a power consumption of the environment components 101A-101C making up environment 100. For example, based on the above configuration where (i) there are N racks, M server machines per rack, and L GPUs per server machine and (ii) the state s[N] is an N-dimensional vector where s[n] has the number of allocated GPUs of rack n, the custom reward condition 286 may be formulated as:
Total allocated

$$GPUs = {\sum }_{n = 1}^{N} s [ n ] ;$$

Total AI server machines powered

$$on = {\sum }_{n = 1}^{N} step ( s [ n ] ) \times M \times L ;$$

$$Utilization = ( Total allocated GPUs ) / ( Total AI server machines powered on ) where step ( x ) = \{ \begin{matrix}0 , x \leq 0 \\ 1 , x > 0\end{matrix} ;$$

Power Consumption=W×(Total allocated GPUs), where W is power consumption. In this example, power consumption W may depend on power consumption of each of the AI server machines and GPUs; and.
Finally, the custom reward condition in this example may be shown as a Q-function of

$$\frac{Utilization}{Power Consumption} = \frac{{\sum }_{n = 1}^{N} s [ n ]}{W \times M \times L \times {( {\sum }_{n = 1}^{N} step ( s [ n ] ) )}^{2}} ,$$

where the Q-function may be linearly proportional to the total number of allocated GPUs and to the inverse of the square of the toral number of powered up racks.

Said another way, in this example, the environment manager 102 (using the trained machine learning model 290 is configured to allocate GPUs of the AI server machines based on the action (e.g., workload) in the action request 201 and to power up and/or power down racks (e.g., environment components 101A-101C) as needed to achieve the least amount of power usage by the environment components 101A-101C at the environment 100. More specifically, using the custom reward condition 286, the trained inference model 290 is configured to generate an inference that would minimize the number of racks (i.e., environment components 101A-101C) that need to be powered up to support the GPU resource demand required to fulfil the action request 201.

In embodiments, in this example, the environment manager 102 may further be configured to detect an operating state of each environment components 101A-101C and automatically power off all environment components 101A-101C with fully idle AI machine servers (e.g., any racks that are fully idle will be automatically powered off by the environment manager 102). Such powering off may also be included in the environment state 202 used in training data 282.

As part of inference model training process 288, the untrained inference model 284 may be trained based on training data 282 and custom reward condition 286 using any applicable training processes and methods associated with Double Q-learning deep neural network algorithm-based models. Once trained inference model 290 is generated, trained inference model 290 may be utilized (e.g., by being hosted, by being remotely called through one or more application programming interfaces (API), or the like) by environment manager 102 as part of a downstream use 292 of the trained inference model 290 as part of the process/method discussed in reference to FIG. 2A.

In particular, turning back to FIG. 2A, as part of environment component usage determination process 203, action request 201 and environment state 202 may be ingested (e.g., as inputs) into the trained inference model 290 (also referred to herein as a “trained machine learning model”) to generate, as an inference, identified environment component 205.

In embodiments, identified environment component 205 may include one or more components (e.g., environment components 101A-101C) of environment 100 identified by the trained inference model 290 as being components a highest return reward component. The highest return reward component may be a component that would return the highest reward based on custom reward condition 286 that was used to obtain trained inference model 290.

For example, in the context of the non-limiting example discussed above (e.g., the AI server farm example), the highest return reward component may be one or more of the environment components 101A-101C that can be utilized to fulfil the action request 201 while also minimizing the overall power usage of the environment 100 (on which the Q-function/custom reward condition is based) by the environment components 101A-101C.

More specifically, referring to FIG. 2A, assume as shown in this figure that: (a) environment component 101A is in a powered-off state (e.g., none of the AI server machines of this rack are utilized at this point of time when the action request 201 was obtained by environment manager 102); (b) environment component 101B is powered on and has available capacity (e.g., some of the GPUs of this rack are being used to process an existing action 230G that was previously sent from environment manager 102 based on a previously obtained action request 201); and (c) environment component 101C is at maximum capacity (e.g., all of the GPUs of this rack are fully utilized to process existing actions 230A-230F).

Further assume that capacity-available environment component 101B is determined by the trained inference model 290 (e.g., based on the information included in the action request 201 and environment state 202) as being able to handle obtained action request 201 without exceeding a GPU utilization limit of environment component 101B (e.g., environment component 101B has ten (10) more GPUs available for use and the workload/action in action request 201 only requires use of six (6) of the ten (10) unused GPUs).

Based on these factors, the identified environment component 205 inference generated by trained inference model 290 in the environment component usage determination process 203 may indicate that the action request 201 should be fulfilled by capacity-available environment component 101B (i.e., capacity-available environment component 101B is the highest return reward component from among the other two environment components 101A and 101C). In this example, this is because by having capacity-available environment component 101B fulfil the action request 201, powered-off environment component 101A may remain powered-off and not use up additional power resources of the environment 100.

Once the identified environment component 205 is generated, environment manager 102 may use identified environment component 205 to instantiate an action placement process 207 to configure the environment components 101A-101C of environment 100 to fulfill (e.g., process, execute, or the like) the action request 201.

For example, in the context of the non-limiting example discussed above (e.g., the AI server farm example), action placement process 207 may be executed by environment manager 102 to provide capacity-available environment component 101B with action initialization instructions 209 to cause capacity-available environment component 101B to process the action(s)/workload(s) required to fulfil action request 201.

In this same example of embodiments disclosed herein, as each environment component 101B and 101C completes the actions/workloads placed within their respective computing resources (e.g., GPUs), these the environment components 101B and 101C may switch into an idle state as all of the actions/workloads are completed. When transitioned into the idle state, such transition may be detected by environment manager 102 (e.g., through environment state 202). As a result, environment manager 102 may cause these environment components 101B and 101C transitioned into the idle state to be powered-off until these environment components 101B and 101C are needed again based on being identified as the highest return reward component in a subsequently generated identified environment component 205 based on a future action request 201 obtained by environment manager 102.

By always being able to select the highest return reward component, environment manager 102 advantageously ensures that environment 100 is being utilized to the best extent based on a pre-specified operating requirement (e.g., specified as part of custom reward condition 286) by a user and/or administrator associated with environment manager 102 and/or environment 100.

In the context of the non-limiting example discussed above (e.g., the AI server farm example), an improved environment 100 that is optimized to utilize the least amount of power to complete all action requests 201 obtained by environment manager 102 may be achieved. This not only directly improves the operations of the environment components 101A-101C (e.g., through being able to provide the necessary power without risking exceeding a power limit of the environment 100) but also improves the shelf-life of the AI machine servers making up each environment components 101A-101C as non-need ones of the AI machine servers can remain powered off to prevent unnecessary wear and tear.

Any of the processes illustrated using the second set of shapes (shown in FIGS. 2A and 2B) may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes in FIGS. 2A and 2B may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning now to FIGS. 3A-3B, FIGS. 3A-3B show an implementation example in accordance with one or more embodiments. In particular, the implementation example shows show the trained inference model 290 (e.g., from FIG. 2B) may be applied (e.g., by environment manager 102) to a scaled-up or scaled-down version of the environment 100 without having the trained inference model 290 be retrained to account for the change in the number of environment components 101A-101N in the scaled-up or scaled-down environment 100.

Starting with FIG. 3A, FIG. 3A shows a vector diagram 301 comprising vectors (e.g., each smaller rectangle making up the overall vector diagram 301). Each of the vectors may represent one environment component (e.g., 101A-101N of FIG. 1) available at an environment 100. For example, in this example shown in FIG. 3A, vector diagram 301 represents an environment 100 having nine (9) environment components.

As further shown in FIG. 3A, each vector of vector diagram 301 includes a number or a word. This number may represent a number of currently utilized resources (e.g., GPUs/AI server machines in the above discussed example of FIGS. 2A-2B) of each environment component. For example, a number of “0” may indicate that none of the resources of an environment component is currently being utilized (e.g., to process, execute, fulfil, or the like, an action request obtained by the environment manager 102); these environment components may be in a powered-off state. Conversely word “MAX” may indicate that all of resources of an environment component is currently being utilized and that the environment component is powered on. Finally, a non-zero number and/or an indication of “Max-X” where X is a non-zero number indicates that the environment component is powered on and has available resources to be utilized by environment manager 102.

In embodiments, as further shown in FIG. 3A, the vectors of vector diagram 301 may be ordered (e.g., by environment manager 102) from least to most utilized resource vectors (e.g., powered off environment components at one terminal end of the vector diagram 301, maximum capacity environment components at the other terminal end, and capacity-available environment components in between). Other numbering and/or ordering schemes of the vectors and the vector diagram 301 to show a current resource utilization state of the environment components of an environment 100 may also be used without departing from the scope of embodiments disclosed herein.

As the operating state of each environment components, the positioning of the vectors of vector diagram 301 may also change. Specifically, as shown in FIG. 3A, after some time has passed, a vector having the number “7” may complete all of the processes it is running and become idle (e.g., 7 becomes 0). When this happens, that vector is shifted over to maintain the above-discussed ordering. More specifically, as shown in FIG. 3A, the new “0” vector is shifted over such that the vector with the number “3” is now next to the vector with the number “23”.

In embodiments, this vector diagram 301 may be provided by the environment 100 to environment manager 102. Alternatively, environment manager 102 may construct this vector diagram 301 using the environment state 202 obtained from the environment 100. This vector diagram 301 may also be ingested into environment component usage determination process 203 (e.g., as an input into trained inference model 290) along with other information included in environment state 202.

Turning now to FIG. 3B, assume that environment 100 has been scaled-up to now include four (4) additional environment components for a total of thirteen (13) environment components. Said another way, an updated computing environment is now obtained after the scale up and a new fixed number of components of the updated computing environment has increased to thirteen (13).

Rather than retraining the trained inference model 290 to generate inferences based on the new fixed number of components, the trained inference model 290 may remain the same. Instead, a sliding window 303 is generated and overlapped onto the vector diagram 301 for the updated computing environment. In embodiments, the size of the sliding window may be based on an original number of environment components (e.g., here nine (9)) on which the trained inference model 290 was initially trained.

In embodiments, the sliding window 303 (also referred to herein as a “sliding scale) may be overlapped over the vector diagram 301 to exclude the most (e.g., largest) number of powered off and maximum capacity environment components as possible. In a sense, the sliding window 303 may be moved across the vector diagram 301 to cover a largest number of the capacity-available vectors (e.g., the capacity-available state environment components) within a boundary of the sliding window 303 that is delimited (e.g., defined) by a size of the sliding window 303.

In particular, as shown in FIG. 3B, at a first point in time (on the left side of FIG. 3B), the vector diagram 301 includes three (3) maximum capacity vectors (e.g., maximum capacity state environment components) and six (6) powered-off vectors (e.g., powered-off state environment components). In this state, the sliding window 303 is placed in a position where the most (e.g., largest) number of powered off and maximum capacity environment components are excluded.

After some time as passed, the state of the vector diagram 301 may change to a future state (e.g., on the right side of FIG. 3B). In this future state, all of the previously maximum capacity vectors have now become capacity-available vectors (e.g., capacity-available state environment components). As a result, the sliding window 303 has been shifted (e.g., by environment manager 102) such that these new capacity-available vectors are now covered within the sliding window 303.

The vectors covered by the sliding window 303 will be the vectors (e.g., environment components) that are considered by the trained inference model 290 when generating the identified environment component 205 while all vectors (e.g., environment components) outside of the sliding window 303 are ignored for the purposes of generating the identified environment component 205.

By excluding the most (e.g., largest) number of powered off and maximum capacity environment components as possible using the sliding window 303, the environment manager 102 may still be able to utilize the trained inference model 290 to provide accurate inferences without having to retrain the trained inference model 290 based on the new number of environment components. In embodiments, if the number of environment components are scaled down (e.g., from the original nine (9) to a number smaller than nine (9) in this example of embodiments disclosed herein), maximum capacity vectors may be added (e.g., based on the number of vectors removed due to the scale down) to maintain the original size of the vector diagram 301.

Similarly, if environment component fails and needs to be taken offline, such failure may be treated as a temporary scale down of the environment (e.g., until the failed environment component is repaired and brought back online) and the vector representing this failed environment component may be treated as a maximum capacity while the failed environment component remains offline.

In embodiments, the environment manager 102 may be configured to automatically determine whether an environment component may need to be taken offline. For example, the environment manager 102 may monitor an operating temperature and power consumption feedback (e.g., included as part of environment state 202) of an environment component to determine whether the environment component has failed. For example, a damaged component of the environment component (e.g., a damaged GPU of a rack) may cause the power consumption of the entire rack to exceed a rated maximum consumption and drive the system (e.g., the entire system of environment 100) to instability. When this happens, from a power consumption perspective, a logical and reasonable mitigation would be to turn off the power to the rack (e.g., environment component) in trouble to confine the problem to that one rack in order to avoid additional damage to surrounding racks (e.g., environment components).

As a result, embodiments disclosed herein is not only able to advantageously provide a system where a trained inference model 290 that optimizes one or more resource usage/allocation within an environment 100 is not needed to be retrained as the environment grows or shrinks (e.g., is scaled up or scaled down, respectively) but is also able to automatically expect the unexpected (e.g., when one or more environment component(s) of the environment fails). As such, an improved system is provided where limited computing resources of the environment manager 102 (and/or any other computing device) that hosts and/or trains the trained inference model 290 is no longer needed to be constantly redirected to model retraining when a state of the environment 100 changes.

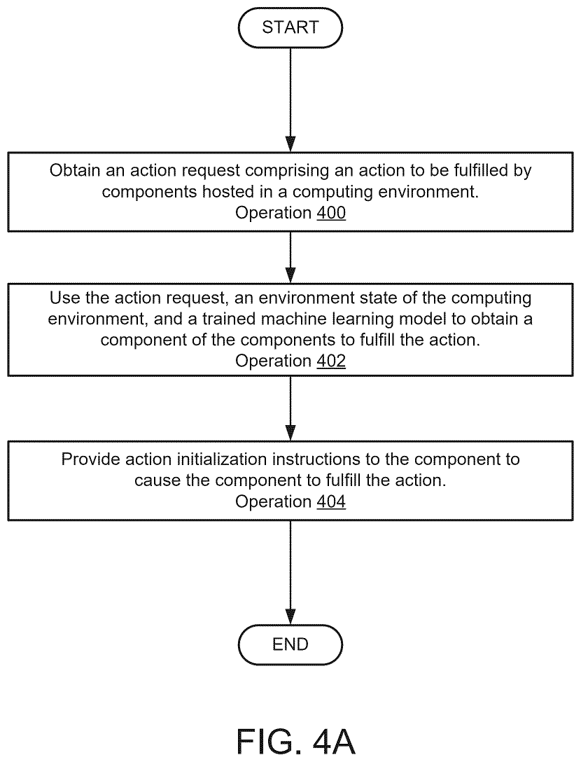

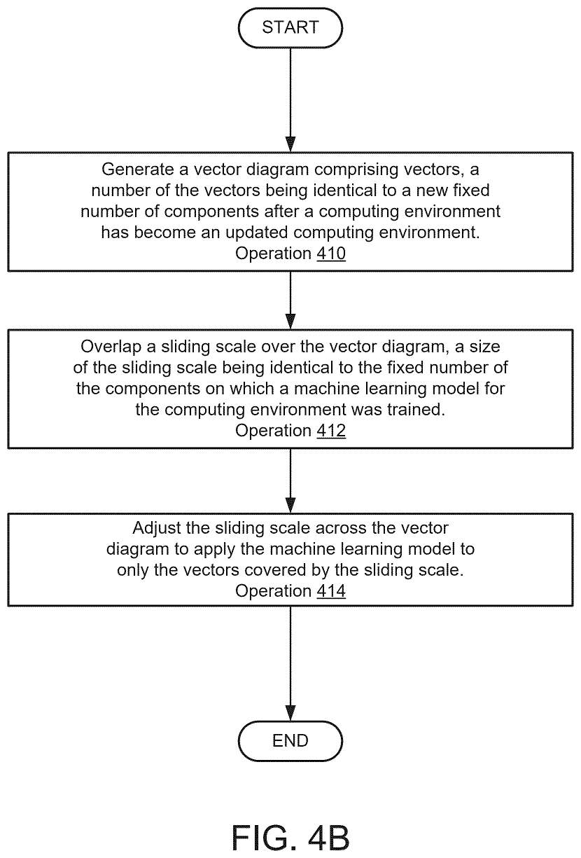

As discussed above, the components of FIGS. 1-3B may perform various methods for managing components hosted in a computing environment. FIGS. 4A and 4B illustrate example methods that may be performed by the components of FIGS. 1-3B. For example, any of the environment manager 102, environment components 101A-101N, or any non-shown data processing systems that are operably connected to these components, may perform all or a portion of the methods. In the diagrams discussed below and shown in FIGS. 4A and 4B, any of the operations may be repeated, performed in different orders, and/or performed in parallel with or in a partially overlapping in time manner with other operations.

Starting with FIG. 4A, in Operation 400 and as discussed above in reference to FIGS. 2A-2B, an action request (e.g., 201 of FIG. 2A) may be obtained. The action request may include an action (e.g., one or more workloads) to be fulfilled by components (e.g., environment components 101A-101N) hosted in a computing environment (e.g., environment 100).

In Operation 402, and as discussed above in reference to FIGS. 2A-2B, the action request, an environment state (e.g., environment state 202) of the computing environment, and a trained machine learning model (e.g., trained machine learning model 290) may be used to obtain a component of the components to fulfil the action.

In embodiments, the component may be one determined by the trained machine learning model based at least on the action request and environment state as a highest return reward component from among the components.

In Operation 404, and as discussed above in reference to FIGS. 2A-2B, action initialization instructions may be provided to the component (e.g., determined as the highest return reward component) to cause the component to fulfil (e.g., process, execute, or the like) the action.

The process may end following operation 404.

Turning to FIG. 4B, in Operation 410 and as discussed above in reference to FIGS. 3A-3B, a vector diagram (e.g., vector diagram 301) comprising vectors may be generated. The vector diagram may be generated in response to a computing environment becoming an updated computing environment. A number of the vectors in the vector diagram may be identical to a new fixed number of components after the computing environment has become the updated computing environment.

In Operation 412, as discussed above in reference to FIGS. 3A-3B, a sliding scale (e.g., a sliding window 303) may be overlapped over the vector diagram (e.g., in the event that the updated computing environment includes more components that than the original number of the components before the computing environment has become the updated computing environment).

In embodiments, a size of the sliding scale being identical to the fixed number of the components on which the trained machine learning model (e.g., trained inference model 290) was trained. Said another way, if the original computing environment contained nine (9) components, the trained machine learning model was trained on these original nine (9) components and the size of the sliding scale would be nine (9).

In Operation 414, as discussed above in reference to FIGS. 3A-3B, the sliding scale may be adjusted slide across the vector diagram to apply the trained inference model to only the vectors covered within the sliding scale.

The process may end following operation 414.

Any of the components illustrated in FIGS. 1-4B may be implemented with one or more computing devices. Turning to FIG. 5, a block diagram illustrating an example of a computing device (also referred to herein as “system 500”) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system-on-a-chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth® transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing components hosted in a computing environment, the method comprising:
obtaining an action request comprising an action to be fulfilled by the components;
using the action request, an environment state of the computing environment, and a trained machine learning model to obtain a component to fulfill the action, the component being one of the components, and the component being one determined by the trained machine learning model based on the action request and environment state as a highest return reward component from among the components; and
providing action initialization instructions to the component to cause the component to fulfill the action.

2. The method of claim 1, wherein the trained machine learning model is a Double Q-learning deep neural network algorithm-based model comprising a Q-function.

3. The method of claim 2, wherein the Q-function is based on a component utilization and a component power consumption of the components.

4. The method of claim 3, wherein each of the components is a powered-off state component, a capacity-available state component, or a maximum capacity state component, and the highest return reward component is a component among the components that can be utilized to fulfil the action while causing a least number of the powered-off state components to be powered-on.

5. The method of claim 4, wherein each of the components is a server rack comprising one or more hardware devices for hosting and processing the action, and powering on one component of the component powers on all of the one or more hardware devices of the one component while powering off the one component powers off all of the one or more hardware devices of the one component.

6. The method of claim 5, each of the one or more hardware devices is a graphical processing unit (GPU).

7. The method of claim 2, wherein the trained machine learning model is trained using a fixed number of the components.

8. The method of claim 7, wherein an updated computing environment may be obtained when new components are added or removed from the computing environment to cause the fixed number of the components to increase or decrease, respectively, to a new fixed number different from the fixed number before the new components were added or removed, and the trained machine learning model is applied to the updated computing environment with the new fixed number of the components without being retrained using the new fixed number.

9. The method of claim 8, further comprising, and after the computing environment has become the updated computing environment:
generating a vector diagram comprising vectors, a number of the vectors being identical to the new fixed number of the components;
overlapping a sliding scale over the vector diagram, a size of the sliding scale being identical to the fixed number of the components on which the trained machine learning model was trained; and
adjusting the sliding scale across the vector diagram to apply the trained machine learning model to only the vectors covered by the sliding scale, the adjusting being performed in response to receiving a new action request after the computing environment has become the updated computing environment.

10. The method of claim 9, wherein
the components are arranged as the vectors of the vector diagram in an order comprising:
powered-off state components of the components at one end of the vector diagram;
maximum capacity state components of the components at an opposite end of the vector diagram; and
capacity-available state components of the components between the powered-off state components and the maximum capacity state components, and
the sliding scale is moved across the vector diagram to cover a largest number of the capacity-available state components within a boundary of the sliding scale that is delimited by the size of the sliding scale.

11. A non-transitory machine-readable medium having instructions stored therein, which when executed by a processor, cause the processor to perform operations for managing components hosted in a computing environment, the operations comprising:
obtaining an action request comprising an action to be fulfilled by the components;
using the action request, an environment state of the computing environment, and a trained machine learning model to obtain a component to fulfill the action, the component being one of the components, and the component being one determined by the trained machine learning model based on the action request and environment state as a highest return reward component from among the components; and
providing action initialization instructions to the component to cause the component to fulfill the action.

12. The non-transitory machine-readable medium of claim 11, wherein the trained machine learning model is a Double Q-learning deep neural network algorithm-based model comprising a Q-function.

13. The non-transitory machine-readable medium of claim 12, wherein the Q-function is based on a component utilization and a component power consumption of the components.

14. The non-transitory machine-readable medium of claim 13, wherein each of the components is a powered-off state component, a capacity-available state component, or a maximum capacity state component, and the highest return reward component is a component among the components that can be utilized to fulfil the action while causing a least number of the powered-off state components to be powered-on.

15. The non-transitory machine-readable medium of claim 14, wherein each of the components is a server rack comprising one or more hardware devices for hosting and processing the action, and powering on one component of the component powers on all of the one or more hardware devices of the one component while powering off the one component powers off all of the one or more hardware devices of the one component.

16. A data processing system, comprising:
a processor; and
a memory coupled to the processor to store instructions, which when executed by the processor, cause the processor to perform operations for managing components hosted in a computing environment, the operations comprising:
obtaining an action request comprising an action to be fulfilled by the components;
using the action request, an environment state of the computing environment, and a trained machine learning model to obtain a component to fulfill the action, the component being one of the components, and the component being one determined by the trained machine learning model based on the action request and environment state as a highest return reward component from among the components; and
providing action initialization instructions to the component to cause the component to fulfill the action.

17. The data processing system of claim 16, wherein the trained machine learning model is a Double Q-learning deep neural network algorithm-based model comprising a Q-function.

18. The data processing system of claim 17, wherein the Q-function is based on a component utilization and a component power consumption of the components.

19. The data processing system of claim 18 wherein each of the components is a powered-off state component, a capacity-available state component, or a maximum capacity state component, and the highest return reward component is a component among the components that can be utilized to fulfil the action while causing a least number of the powered-off state components to be powered-on.

20. The data processing system of claim 19, wherein each of the components is a server rack comprising one or more hardware devices for hosting and processing the action, and powering on one component of the component powers on all of the one or more hardware devices of the one component while powering off the one component powers off all of the one or more hardware devices of the one component.
